(19) United States
(12) Patent Application Publication
(10) Pub. No.: US 2008/0312976 A1
(43) Pub. Date: Dec. 18, 2008

(54) ENHANCED TRAVEL RESERVATION SYSTEM AND METHOD

(75) Inventors: Flynn X. Huang, Bellevue, WA (US); Chen Wang, Bellevue, WA (US); Harvey Chen, Bellevue, WA (US)

Correspondence Address: DAVIS WRIGHT TREMAINE, LLP/Seattle, 1201 Third Avenue, Suite 2200, SEATTLE, WA, 98101-3045, US

(73) Assignee: BIG DEAL CORPORATION, Bellevue, WA (US)

(21) Appl. No.: 12/099,613

(22) Filed: Apr. 8, 2008

Related U.S. Application Data
(60) Provisional application No. 60/943,811, filed on Jun. 13, 2007.

(51) Int. Cl. G06Q 10/00

(52) U.S. Cl. 705/5

(57) ABSTRACT

An enhanced travel reservation system and method allows for contribution to reservation offer and selection of a travel reservation provider by a traveler while also allowing for negotiation to occur between the traveler and the travel reservation provider. Before a final booking both the traveler and the travel reservation provider can negotiate over unsettled issues directly with each other. In implementations, the system deducts a fee from an account of the travel reservation provider to enter a final negotiation phase. Depending upon the result of the final negotiation, the traveler will either book a reservation directly or decline. In this manner the traveler is involved with travel reservation offer definition while retaining control over the reservation process so that the traveler can avoid unsatisfactory results.

### CROSS REFERENCE TO RELATED APPLICATION

This application claims priority benefit of provisional application Ser. No. 60/943,811 filed Jun. 13, 2007, the content of which is incorporated in its entirety.

### BACKGROUND OF THE INVENTION

1. Field of the Invention

The present invention is directed generally to travel reservation systems.

2. Description of the Related Art

Travel reservation providers include hotels, vehicle rental companies, airlines, and cruise lines. The travel reservation providers offer various reservations pertaining to goods and/or services that they provide on a temporary basis such as rooms, vehicles, flights, and cruises. Some conventional travel reservation systems allow selection by a traveler of reservation offers defined by various travel reservation providers. Other conventional travel reservation systems allow a traveler to define a reservation offer but reserve selection of a travel reservation provider that would fulfill the reservation offer to the prerogative of the system.

### BRIEF DESCRIPTION OF THE SEVERAL VIEWS OF THE DRAWING(S)

FIG. 1 is a schematic block diagram of a computer and associated equipment that is used with implementations of an enhanced reservation system.

FIG. 2 is a representative schematic diagram of an implementation of the enhanced reservation system.

FIG. 3 is a schematic diagram of an implementation of an intermediator of the reservation system of FIG. 2.

FIG. 4 is an interaction diagram of a first method for operation of the reservation system of FIG. 2.

FIG. 5 is an interaction diagram of a second method for operation of the reservation system of FIG. 2.

### DETAILED DESCRIPTION OF THE INVENTION

An enhanced travel system and method described herein allows for contribution to reservation offer and selection of a travel reservation provider by a traveler while also allowing for negotiation to occur between the traveler and the travel reservation provider. For instance, a traveler can submit a desired query regarding a hotel stay including price and customized requests through the system to be sent to a variety of hotels. Those hotels that are interested can then respond via e-mail or other method to the query through the system. Before a final booking both the traveler and the hotel can negotiate over unsettle issues directly with each other. In implementations, the system deducts a fee from an account of the hotel selected by the traveler to enter a final negotiation phase. Depending upon the result of the final negotiation, the traveler will either book a reservation directly with the hotel or decline. In this manner the traveler is involved with travel reservation offer definition while retaining control over the reservation process so that the traveler can avoid unsatisfactory results.

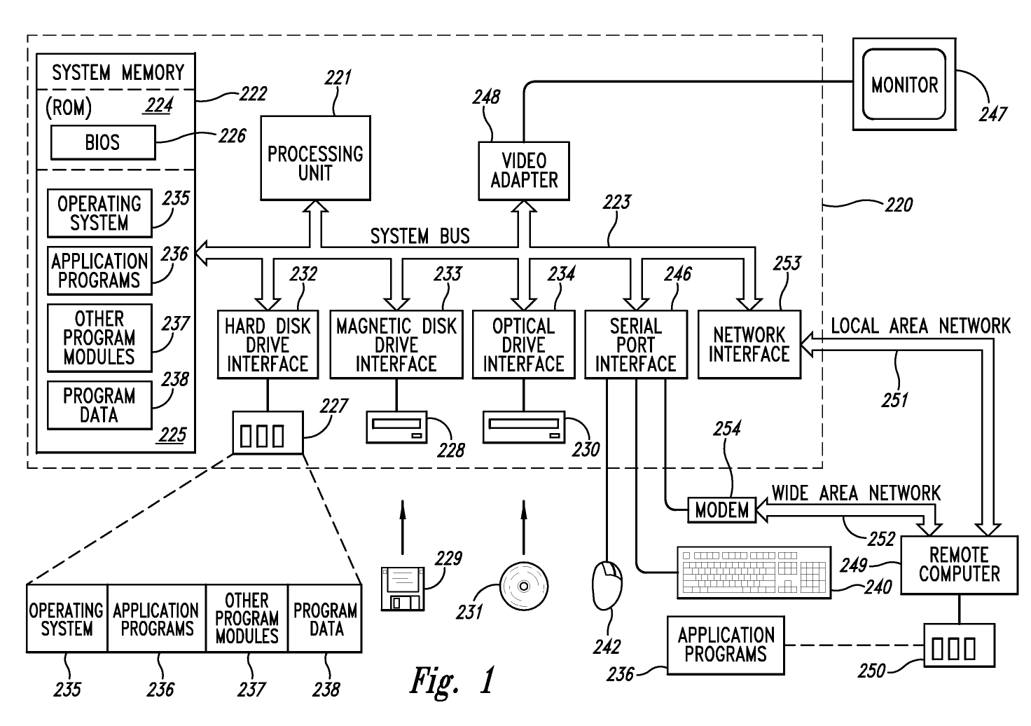

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices (including wireless devices such as cell phones, personal data assistants, etc), multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced as has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

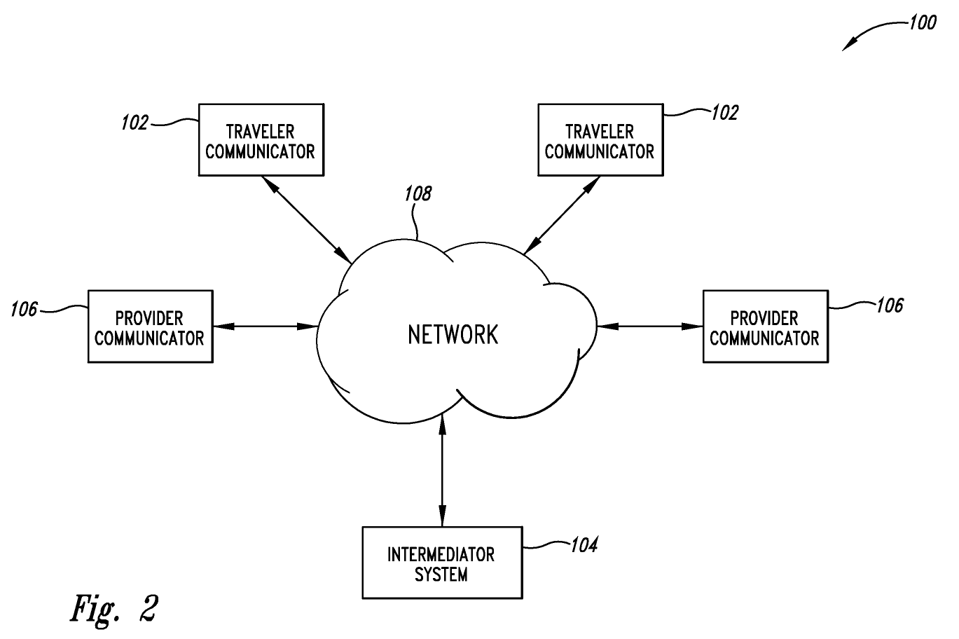

A representative implementation of an enhanced travel reservation system 100 is depicted in FIG. 2 as including traveler communicators 102, an intermediator system 104, and travel reservation provider communicators 106 all communicatively linked via a network 108. In some implementations, the network 108 can be a computer network such as a LAN, internet, WAN or other network and in other implementations the network can be a cellular network or combination thereof. In some implementations, the traveler communicators 102 and the provider communicators 106 can be personal computers or workstations with web-browsers and in other implementations can be hand-held wireless devices such cell phones, PDAs, or smaller computers. The traveler communicator 102 can be operated by an end-user potential traveler that will eventually use the goods and/or services of an agreed upon reservation. In other cases, the traveler communicator 102 can be used by an agent of the end-user potential traveler. The provider communicator 106 can be used by the travel reservation provider such as a hotel, a rental car company, a cruise line, or an airline.

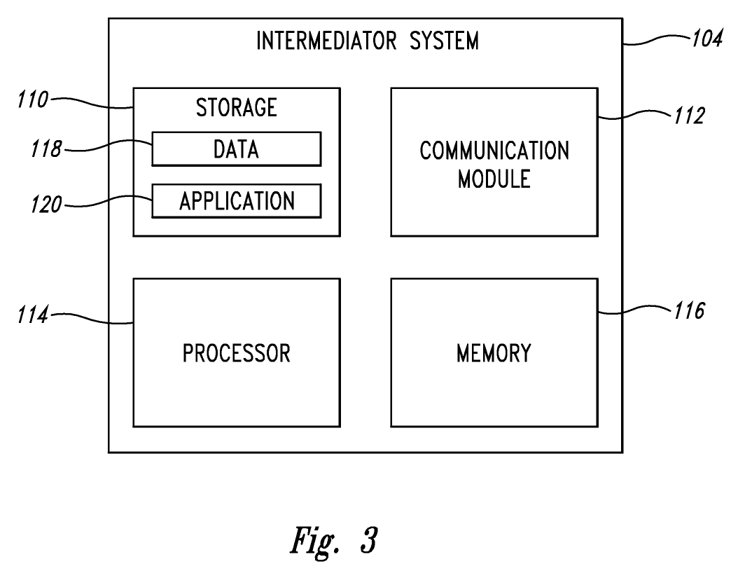

The intermediator system 104 is shown in further detail is FIG. 3 to include storage 110, a communication module 112, a processor 114, and a memory 116. The storage further includes data 118 and applications 120. The data 118 can include data regarding travel reservation offer requests sent by the traveler communicators 102, travel reservation offers sent by provider communicators 106, and various communications between the traveler communicators 102, the intermediator system 104, and the provider communicators 106. The applications 120 can include one or more databases, server, web-server support, and can also include communication capability to be used with the communication module 112 for communication with the travel communicators 102 and the provider communicators 106 via the network 108.

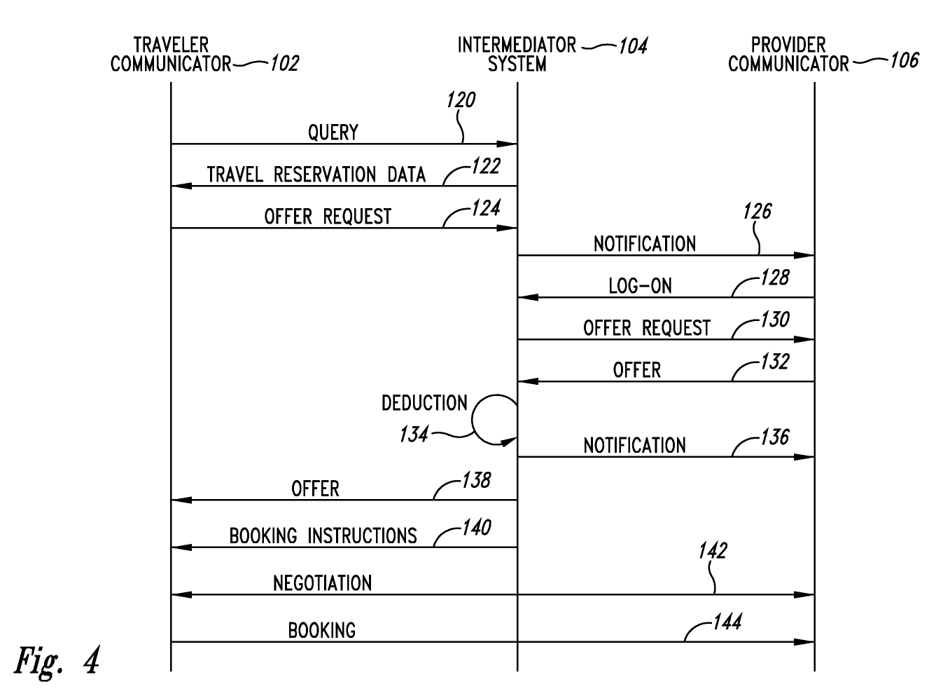

A first operation of the travel reservation system 100 is depicted in FIG. 4 with the traveler communicator 102 sending a query (step 120) to the intermediator system 104. For instance, for an exemplary case involving a hotel reservation, the query could contain dates of stay, room particulars, a desired location (such as a city or other area), and maximum cost. In reply to the query, the intermediator system 104 sends travel reservation data (step 122) about the goods and/or services of various travel reservation providers to the traveler communicator 102. For the hotel case, the travel reservation data could be information contained in the storage 110 on various hotels and their rooms in the desired location. The travel reservation data may not contain all of the particulars of the query depending upon the data 118 and certain search rules contained in the storage 110 to be implemented by the processor 114.

If one of the goods and/or services described in the travel reservation data is sufficiently desirable to the user of the traveler communicator 102, the traveler communicator will send a travel reservation offer request (step 124) to the intermediator system 104. The intermediator system 104 then sends notification (step 126) to the provider communicator 108 of the desired travel reservation provider who logs-on (step 128) to the intermediator system 104 to receive the offer request (step 130) from the intermediator system. After review, if desired, the travel reservation provider can send to the intermediator system 104, a travel reservation offer (step 132) that may contain further detail or modifications with respect to that contained in the travel reservation data.

The intermediator system 104 deducts (step 134) from an account of the travel reservation provider and sends a notification (step 136) to the provider communicator 106 of the deduction. The account of the travel reservation provider could be denominated in legal tender or in fiat currency, points or credits issued by an operator of the intermediator system 104. The intermediator system 104 sends the travel reservation offer (step 138) received from the provider communicator 106 along with booking instructions (step 140) contained in the data 118 to the traveler communicator 102. The booking instructions can contain contact information for the travel reservation provider. In the hotel case, the contact information would include the address and phone number of the hotel. In other implementations, the physical address of the hotel may be contained in the travel reservation data, but the phone number and/or e-mail address of the hotel can be contained in the booking instructions.

The traveler via the traveler communicator 102 contacts the travel reservations provider and works out any final issues through negotiations (step 142). Once final issues are worked out between the traveler and the travel reservation provider, the traveler via the traveler communicator 102 books a reservation (step 144) with the travel reservation provider via the provider communicator 106 over the network 108. In the hotel case, the traveler books a room with the hotel.

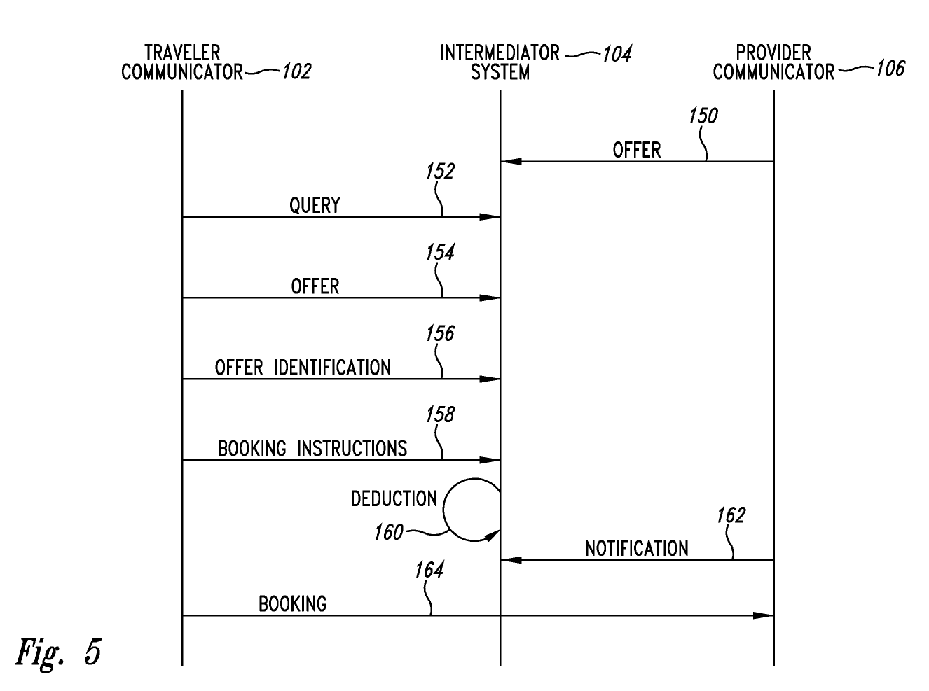

A second operation of the travel reservation system 100 is shown in FIG. 5 to include the provider communicator 106 sending a travel reservation offer (step 150) to the intermediator system 104, which is then contained in the data 118 of the storage 110. The traveler communicator 102 sends a query (step 152) to the intermediator system 104 as to what travel reservation offers are currently available for certain criteria such as location, dates, price, etc. Typically the criteria of the query may have some vagueness as not to completely describe a travel reservation offer. The intermediator system 104 sends one or more travel reservation offers (step 154) that are contained in storage 110 that match at least some of the criteria of the query. The exactness of the match required can be dependent upon rules contained in the storage 110. From the one or more travel reservation offers received, if desired, one is selected and identification of the selection is sent from the traveler communicator 102 to the intermediator system 104 (step 156).

The intermediator system 104 sends booking instructions (step 158) to the traveler communicator 102 in accordance with the offer identification received. The intermediator system 104 deducts value from an account of the travel reservation provider (step 160) and sends notification of such to the provider communicator 106 (step 162). The booking instructions contain contact information, which the traveler uses to send via the traveler communicator 102 a booking to the provider communicator 106 (step 164).

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer. It is understood that steps described above involving the first and second operations of the traveler communicator 102, the intermediator system 104, and the provider communicator 106 of the travel reservation system 100 can have associated instructions contained in one or more computer readable media such as but not limited to tape, floppy, CD, DVD, memory, optical, etc.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

From the foregoing it will be appreciated that, although specific implementations have been described herein for purposes of illustration, various modifications may be made without deviating from the spirit and scope of the invention.

The invention claimed is:

1. For communication between a first party being one of the following: a traveler and an agent of a traveler, and a second party being a travel reservation provider, a computer-readable media containing instructions to implement a method on a computer, the method comprising:
receiving a request for a travel reservation offer from a first communicator associated with the first party;
transmitting the request for the travel reservation offer to a second communicator associated with the second party;
receiving the travel reservation offer from the second communicator;
deducting from an account of the second party;
transmitting the travel reservation offer to the first communicator; and
transmitting instructions to book the travel reservation offer to the first communicator, the booking instructions including contact information of the second party.

2. The method of claim 1, further including:
transmitting a notification of the received request for the travel reservation offer to the second communicator; and
receiving a log-on from the second communicator regarding the received request for the travel reservation offer.

3. The method of claim 1, further including transmitting notification of the deducting to the second communicator

4. The method of claim 1 wherein the account of the second party being subject of the deducting is denominated in one of the following: legal tender, fiat currency, points, and credits.

5. The method of claim 1, further including:
receiving a query from the first communicator, the query containing travel reservation criteria; and
transmitting travel reservation data associated with the travel reservation criteria to the first communicator.

6. The method of claim 5 wherein the travel reservation criteria is related to hotel reservations and the travel reservation data is related to a plurality of hotel reservation offers.

7. The method of claim 6 wherein the travel reservation criteria includes identification of a city and time of stay.

8. The method of claim 5 wherein the travel reservation criteria is related to airline reservations and the travel reservation data is related to a plurality of airline reservation offers.

9. The method of claim 5 wherein the travel reservation criteria is related to rental vehicle reservations and the travel reservation data is related to a plurality of rental vehicle reservation offers.

10. For communication between a first party being one of the following: a traveler and an agent of a traveler, and a second party being a travel reservation provider, a method comprising:
receiving a request for a travel reservation offer from a first communicator associated with the first party;
transmitting the request for the travel reservation offer to a second communicator associated with the second party;
receiving the travel reservation offer from the second communicator;
deducting from an account of the second party;
transmitting the travel reservation offer to the first communicator; and
transmitting instructions to book the travel reservation offer to the first communicator, the booking instructions including contact information of the second party.

11. The method of claim 10, further including:
transmitting a notification of the received request for the travel reservation offer to the second communicator; and
receiving a log-on from the second communicator regarding the received request for the travel reservation offer.

12. The method of claim 10, further including transmitting notification of the deducting to the second communicator

13. The method of claim 10 wherein the account of the second party being subject of the deducting is denominated in one of the following: legal tender, fiat currency, points, and credits.

14. The method of claim 10, further including:
receiving a query from the first communicator, the query containing travel reservation criteria; and
transmitting travel reservation data associated with the travel reservation criteria to the first communicator.

15. The method of claim 14 wherein the travel reservation criteria is related to hotel reservations and the travel reservation data is related to a plurality of hotel reservation offers.

16. The method of claim 15 wherein the travel reservation criteria includes identification of a city and time of stay.

17. The method of claim 14 wherein the travel reservation criteria is related to airline reservations and the travel reservation data is related to a plurality of airline reservation offers.

18. The method of claim 14 wherein the travel reservation criteria is related to rental vehicle reservations and the travel reservation data is related to a plurality of rental vehicle reservation offers.

19. For communication between a first party being one of the following: a traveler and an agent of a traveler, and a second party being a travel reservation provider, a computer-readable media containing instructions to implement a method on a computer, the method comprising:
receiving a first plurality of travel reservation offers from a second plurality of communicators;
receiving a query from a first communicator associated with the first party, the query containing travel reservation criteria;
transmitting a selection of the first plurality of travel reservation offers to the first communicator in response to receiving the query;
receiving identification of one of the selection of the first plurality of travel reservation offers from the first communicator, the second party being the travel reservation provider of the one of the selection;
transmitting booking instructions including contact information of the second party to the first communicator; and
deducting from an account of the second party.

20. The method of claim 19 wherein the travel reservation criteria is related to hotel reservations and the travel reservation data is related to a plurality of hotel reservation offers.

21. The method of claim 20 wherein the travel reservation criteria includes identification of a city and time of stay.

22. The method of claim 19 wherein the travel reservation criteria is related to airline reservations and the travel reservation data is related to a plurality of airline reservation offers.

23. The method of claim 19 wherein the travel reservation criteria is related to rental vehicle reservations and the travel reservation data is related to a plurality of rental vehicle reservation offers.

24. For communication between a first party being one of the following: a traveler and an agent of a traveler, and a second party being a travel reservation provider, a method comprising:
receiving a first plurality of travel reservation offers from a second plurality of communicators;
receiving a query from a first communicator associated with the first party, the query containing travel reservation criteria;
transmitting a selection of the first plurality of travel reservation offers to the first communicator in response to receiving the query;
receiving identification of one of the selection of the first plurality of travel reservation offers from the first communicator, the second party being the travel reservation provider of the one of the selection;
transmitting booking instructions including contact information of the second party to the first communicator; and
deducting from an account of the second party.

25. The method of claim 24 wherein the travel reservation criteria is related to hotel reservations and the travel reservation data is related to a plurality of hotel reservation offers.

26. The method of claim 25 wherein the travel reservation criteria includes identification of a city and time of stay.

27. The method of claim 24 wherein the travel reservation criteria is related to airline reservations and the travel reservation data is related to a plurality of airline reservation offers.

28. The method of claim 24 wherein the travel reservation criteria is related to rental vehicle reservations and the travel reservation data is related to a plurality of rental vehicle reservation offers.
